(19) United States
(12) Patent Application Publication
(10) Pub. No.: US 2026/0204835 A1
(43) Pub. Date: Jul. 16, 2026

(54) CONNECTOR

(71) Applicant: Yazaki Corporation, Tokyo (JP)

(72) Inventors: Yuuhei Takeshita, Makinohara-shi (JP); Koki Iwakura, Makinohara-shi (JP); Masayuki Ishigami, Masayuki (JP); Moeto Osawa, Fujieda-shi (JP)

(21) Appl. No.: 19/447,513

(22) Filed: Jan. 13, 2026

(30) Foreign Application Priority Data
Jan. 14, 2025 (JP) 2025-004552

(51) Int. Cl. H01R 13/512; H01R 13/426; H01R 13/631; H01R 13/639; H01R 13/648

(52) U.S. Cl. CPC H01R 13/512; H01R 13/426; H01R 13/6315; H01R 13/639; H01R 13/648

(57) ABSTRACT

A connector of one embodiment includes: a terminal fitting attached to a terminal of an electric wire; a housing including a terminal housing portion that houses the terminal fitting inward and an electric wire housing portion that houses the electric wire inward and pulls out the electric wire outward; and a shield shell including a cylindrical-shaped cylindrical portion that covers the electric wire housing portion from the outside, and a fixing portion that protrudes to one side from the cylindrical portion and is fixed to a counterpart case in a cantilevered manner, in which the fixing portion includes a contact portion that comes into contact with the counterpart case in the cantilevered fixed state.

### BACKGROUND OF THE INVENTION

### Field of the Invention

The embodiments of the present disclosure relate to a connector.

Priority is claimed on Japanese Patent Application No. 2025-004552 filed in Japan on January 14, 2025, the content of which is incorporated herein by reference.

### Description of Related Art

Patent Document 1 and Patent Document 2 disclose a connector including a terminal fitting attached to a terminal of an electric wire, a housing in which the terminal fitting and the electric wire terminal side are housed, and a shield shell covering an electric wire housing portion of the housing from the outside. In the connectors disclosed in Patent Document 1 and Patent Document 2, a fixing portion protruding from a flange portion of a shield shell is screwed and fixed to a female screw portion of a case of the counterpart device with a male screw member.

### Prior Art Document

### Patent Document

Patent Document 1: Japanese Unexamined Patent Application, First Publication No. 2021-190328

Patent Document 2: Japanese Unexamined Patent Application, First Publication No. 2023-61411

### SUMMARY OF THE INVENTION

When a shield shell is fixed to the counterpart case in a cantilevered manner and the shield shell is inclined at the time of completion of the fixing, a gap may be generated on the side opposite to the fixing side. In a case where a gap is generated between the shield shell and the counterpart case, there is a concern about a decrease in shield performance of the shield shell, damage due to external factors such as vibration, and the like.

One embodiment provides a connector capable of suppressing generation of the gap due to inclination of the shield shell.

A connector of one embodiment includes: a terminal fitting attached to a terminal of an electric wire; a housing including a terminal housing portion that houses the terminal fitting inward and an electric wire housing portion that houses the electric wire inward and pulls out the electric wire outward; and a shield shell including a cylindrical-shaped cylindrical portion that covers the electric wire housing portion from the outside, and a fixing portion that protrudes to one side from the cylindrical portion and is fixed to a counterpart case in a cantilevered manner, in which the fixing portion includes a contact portion that comes into contact with the counterpart case in the cantilevered fixed state.

According to one embodiment, it is possible to suppress generation of a gap due to inclination of a shield shell.

### BRIEF DESCRIPTION OF THE DRAWINGS

FIG. 1 is a perspective view of a connector of an embodiment;

FIG. 2 is a perspective view of the connector of the embodiment as viewed from a side opposite to FIG. 1 together with a counterpart connector;

FIG. 3 is an exploded perspective view of the connector of the embodiment;

FIG. 4 is a view of the connector of the embodiment as viewed from a terminal housing portion side;

FIG. 5 is a partially enlarged view taken along line V-V in FIG. 4;

FIG. 6 is a cross-sectional view illustrating a partially enlarged view of a cross section taken along line VI-VI in FIG. 4 together with a counterpart case;

FIG. 7 is an explanatory view when fixing of a connector of a comparative example is completed;

FIG. 8 is an explanatory view when fixing of the connector of the embodiment is completed;

FIG. 9 is a cross-sectional view corresponding to FIG. 6, illustrating a connector of a second embodiment together with a counterpart case; and

FIG. 10 is a cross-sectional view corresponding to FIG. 6, illustrating a connector of a third embodiment together with a counterpart case.

### DETAILED DESCRIPTION OF THE INVENTION

Hereinafter, embodiments will be described with reference to the drawings. In the following description, expressions indicating relative or absolute arrangements, such as “parallel,” “orthogonal,” “center,” and “coaxial,” do not only mean such arrangements or states in a strict sense, but also include arrangements or states in which there is a relative displacement with an angle or distance to the extent that a tolerance or the same function can be obtained. In the drawings used in the following description, the scale of each member may be changed as appropriate to make each member recognizable.

### Connector

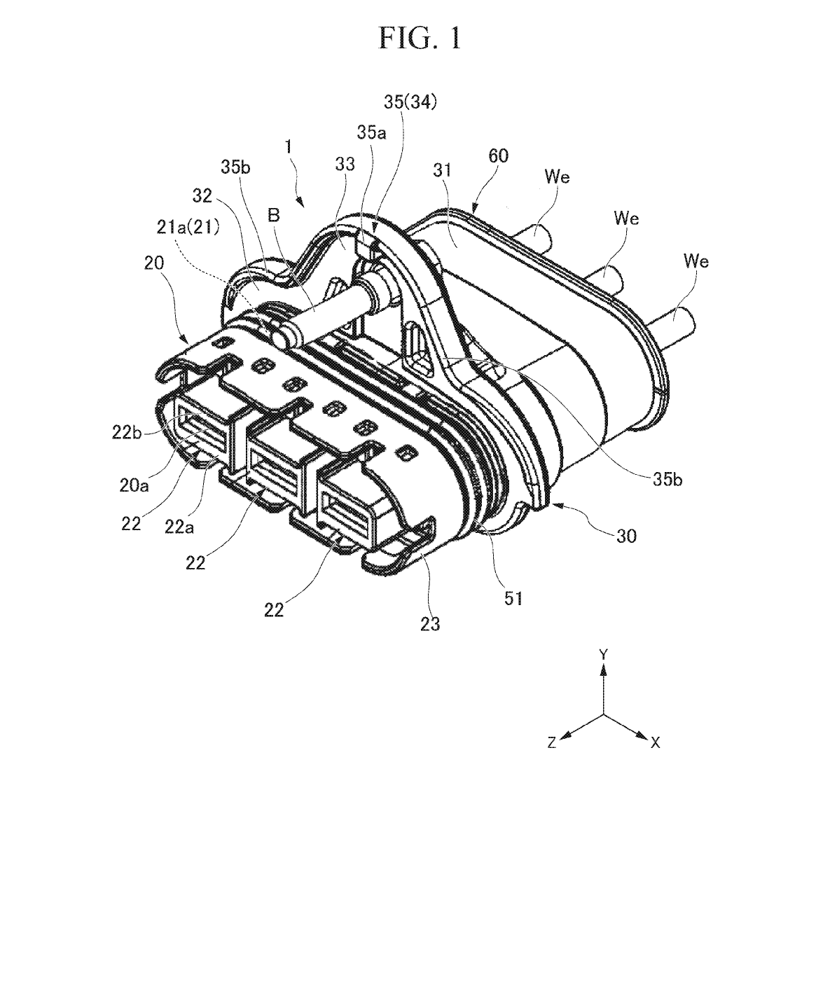

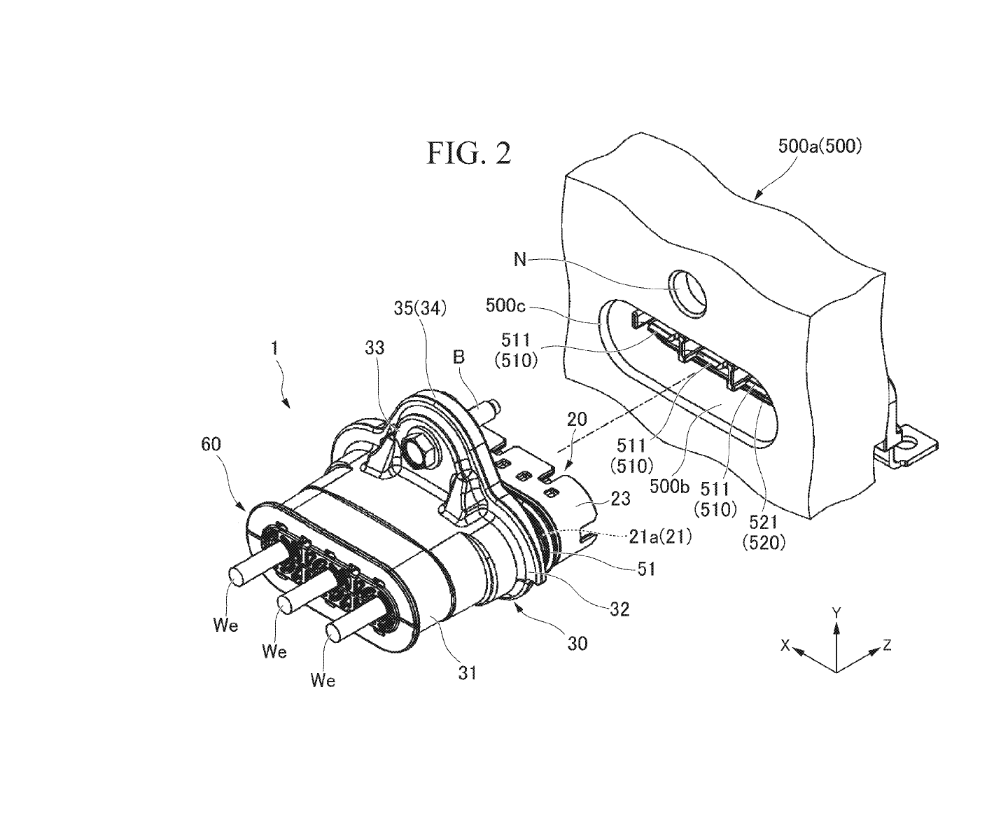

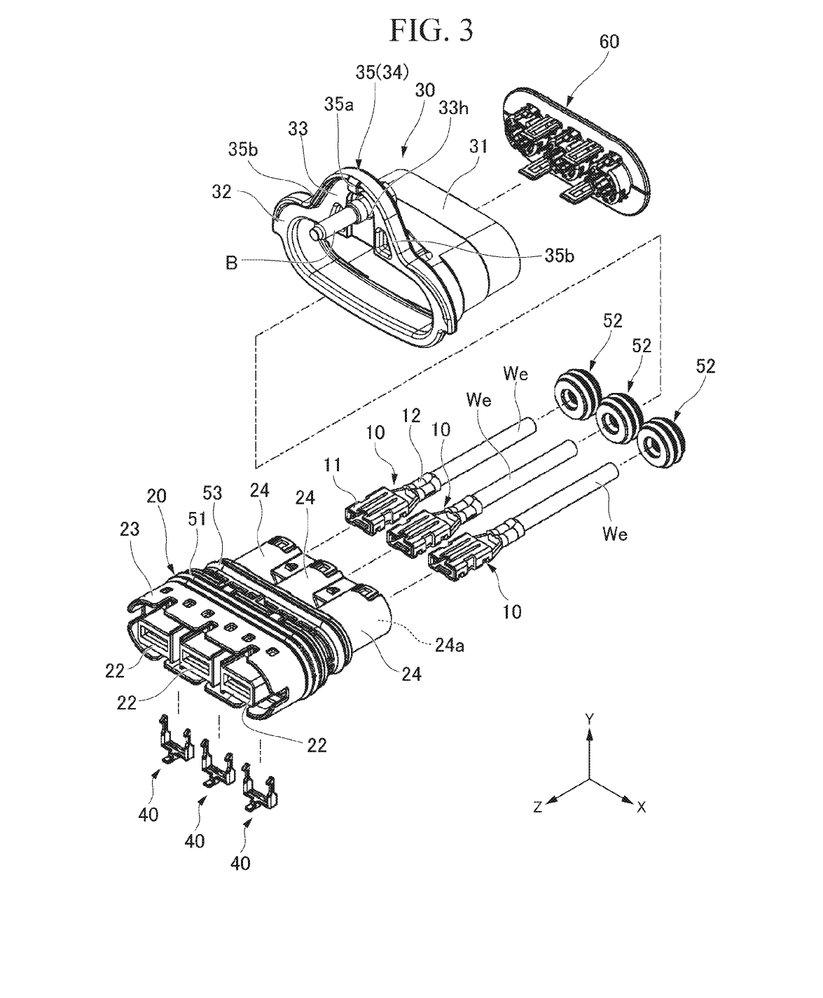

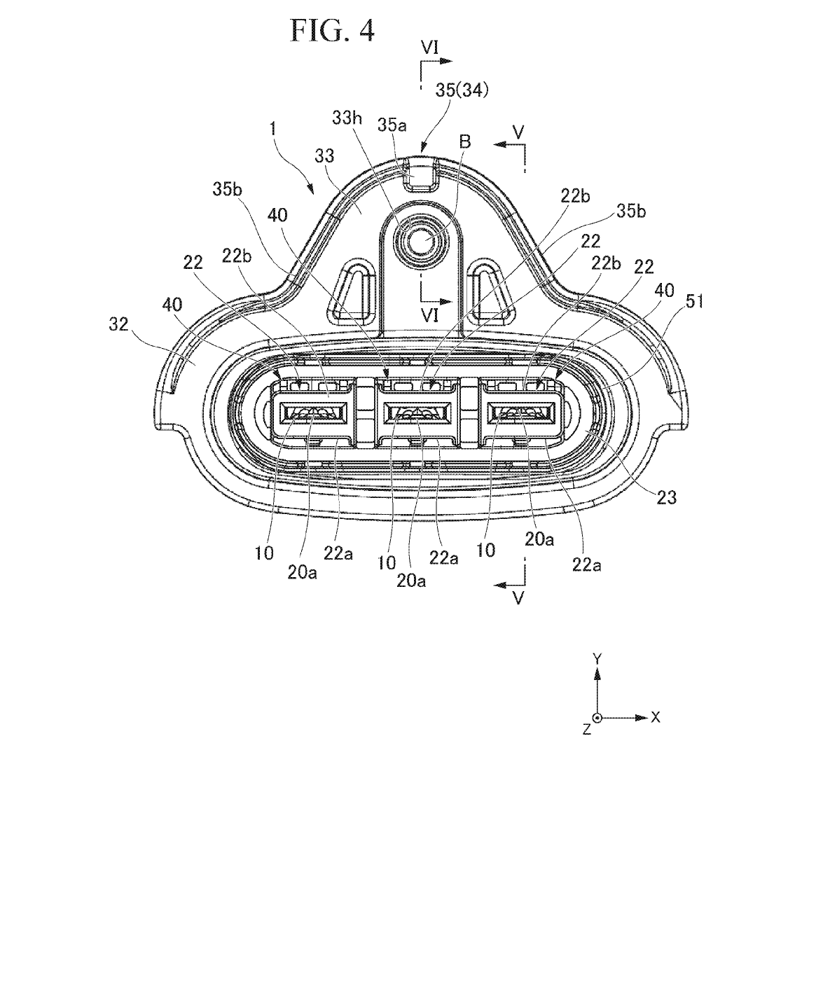

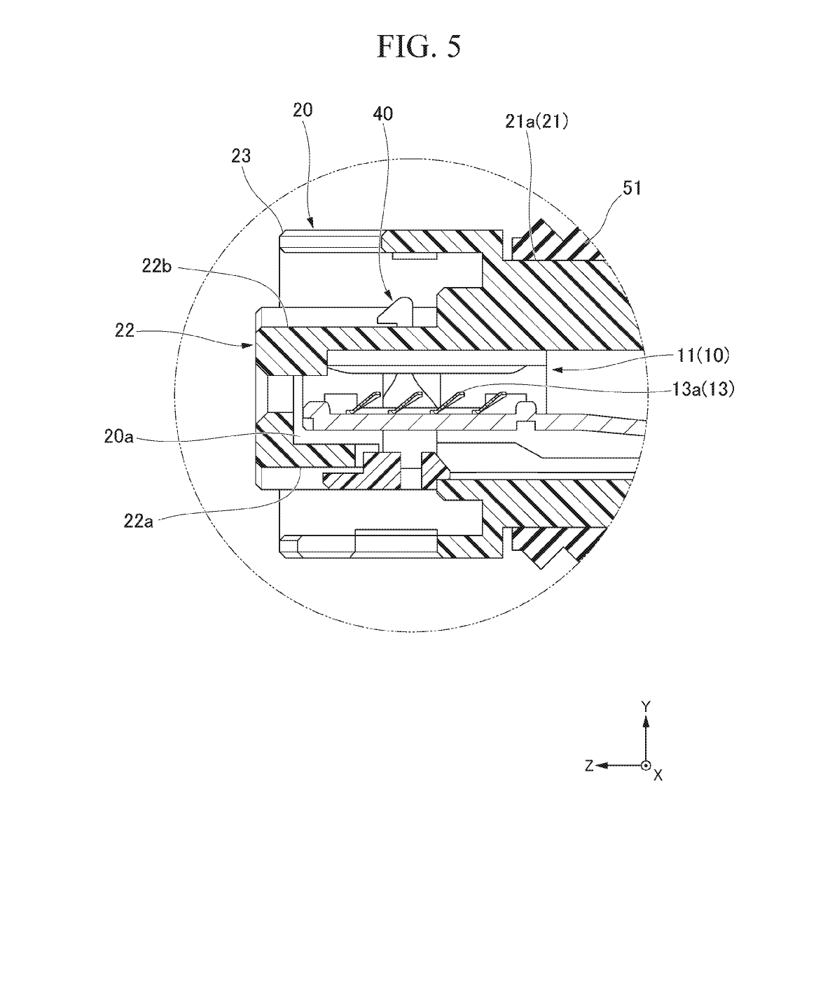

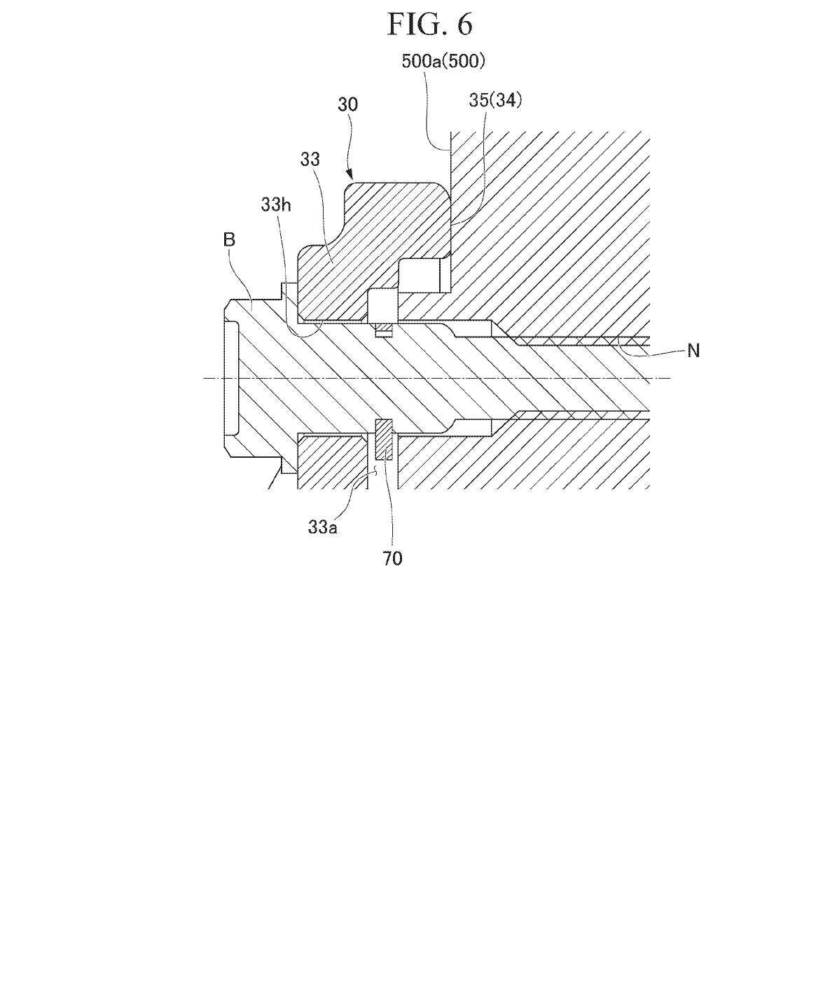

FIG. 1 is a perspective view of a connector 1 of an embodiment. FIG. 2 is a perspective view of the connector 1 of the embodiment as viewed from a side opposite to FIG. 1 together with a counterpart connector. FIG. 3 is an exploded perspective view of the connector 1 of the embodiment. FIG. 4 is a view of the connector 1 of the embodiment as viewed from a terminal housing portion 22 side. FIG. 5 is a partially enlarged view taken along line V-V in FIG. 4. FIG. 6 is a cross-sectional view illustrating a partially enlarged view of a cross section taken along line VI-VI in FIG. 4 together with a counterpart case 500a.

Referring to FIGS. 1 to 6 collectively, the connector 1 is attached to the terminal of an electric wire We. The connector 1 is electrically connected to a device (for example, an inverter of a vehicle) ahead of the electric wire We. The connector 1 is electrically connected to a counterpart terminal fitting 510 of a counterpart device 500 (for example, a rotating machine of a vehicle), whereby the counterpart device 500 and the device ahead of the electric wire We are electrically connected to each other. The counterpart terminal fitting 510 is disposed in a counterpart fitting space 500b of the counterpart case 500a (the case of the counterpart device 500). The counterpart terminal fitting 510 is electrically connected to the connector 1 (terminal fitting 10) fitted into the counterpart fitting space 500b.

The connector 1 includes three combinations of the terminal fitting 10 and the electric wire We that form a pair. Note that the number of combinations of the terminal fitting 10 and the electric wire We that form a pair is not limited to the above and can be changed according to design specifications.

The connector 1 includes the terminal fitting 10 attached to the terminal of the electric wire We, a housing 20 having the terminal housing portion 22 that houses the terminal fitting 10 inward, and an electric wire housing portion 24 that houses the electric wire We inward and pulls out the electric wire We outward, and a shield shell 30 having a cylindrical-shaped cylindrical portion 31 that covers the electric wire housing portion 24 from the outside, and a fixing portion 33 that protrudes from the cylindrical portion 31 to one side and is fixed to the counterpart case 500a in a cantilevered manner.

In the following description, an orthogonal coordinate system of X, Y, and Z will be used as necessary. Of the X direction, the Y direction, and the Z direction, the arrow side in the drawing will be referred to as a plus (+) side, and the side opposite to the arrow will be referred to as a minus (-) side. The Z direction corresponds to a fitting direction of the connector 1 and the counterpart connector. The +Z side corresponds to the front side in the fitting direction (side approaching the counterpart connector, front side) as viewed from the connector 1. The -Z side corresponds to the release side in the fitting direction (the side away from the counterpart connector, rear side) as viewed from the connector 1.

### Terminal fitting

The terminal fitting 10 is formed of a conductive material such as metal. For example, the terminal fitting 10 is formed by press molding such as bending or cutting of a metal plate as a base material. The terminal fitting 10 is electrically connected to the electric wire We by being attached to the terminal of the electric wire We. The terminal fitting 10 is physically and electrically connected to the counterpart terminal fitting 510 arranged in the counterpart fitting space 500b. The terminal fitting 10 includes a terminal connection portion 11 physically and electrically connected to the counterpart terminal fitting 510, and an electric wire connection portion 12 physically and electrically connected to the terminal of the electric wire We.

The terminal connection portion 11 is connected to a counterpart terminal connection portion 511 of the counterpart terminal fitting 510 by fitting. The terminal connection portion 11 is formed in a cylindrical female terminal shape. The counterpart terminal connection portion 511 is inserted into the terminal connection portion 11. As the housing 20 of the connector 1 is inserted into the counterpart fitting space 500b, the counterpart terminal connection portion 511 is inserted into the terminal connection portion 11 in a direction (-Z direction) opposite to the insertion direction (+Z direction) of the housing 20. The terminal connection portion 11 is formed in an angular cylindrical shape (female terminal shape) having four wall surfaces. The counterpart terminal connection portion 511 is formed in a flat shape (male terminal shape).

A contact member 13 having an elastic contact portion 13a is provided inside the terminal connection portion 11. The elastic contact portion 13a is a portion that ensures a contact pressure between the contact and the counterpart terminal connection portion 511 by a resilient force due to elastic deformation. The elastic contact portion 13a is provided separately from the terminal connection portion 11 (terminal fitting 10). Note that the elastic contact portion 13a may be provided integrally with the terminal connection portion 11 (terminal fitting 10).

The elastic contact portion 13a is disposed inside the terminal connection portion 11 by assembling the contact member 13 inside the terminal connection portion 11. The elastic contact portion 13a contacts one plane of the flat counterpart terminal connection portion 511. The elastic contact portion 13a makes, for example, a resilient force in an orthogonal direction act on one plane of the counterpart terminal connection portion 511.

The electric wire connection portion 12 is physically and electrically connected to the electric wire We by, for example, crimping or welding with respect to the core wire of the terminal of the electric wire We. The electric wire connection portion 12 is crimped to the core wire, for example, by swaging and connecting two barrel pieces to the uncovered core wire.

The terminal fitting 10 is formed in a straight shape in which the terminal connection portion 11 and the electric wire connection portion 12 are arranged on a straight line. The electric wire We is pulled out from the electric wire connection portion 12 in the extending direction (Z direction) of the terminal fitting 10 along the straight line. Note that, in the terminal fitting 10, the terminal connection portion 11 and the electric wire connection portion 12 may be arranged to be orthogonal to each other or may be arranged to intersect each other.

### Housing

The housing 20 is formed of an insulating material such as synthetic resin. The housing 20 includes the terminal housing portion 22 that houses the terminal fitting 10 inward, and the electric wire housing portion 24 that houses the electric wire We inward and pulls out the electric wire We outward. The housing 20 houses the terminal fitting 10 and the electric wire We at an inner housing completion position. In the housing 20, the terminal fitting 10 is held in the housed state at the housing completion position, and the electric wire We is pulled out from the inside to the outside.

The housing 20 has a fitting wall 21 fitted into the counterpart fitting space 500b from an insertion port 500c along the +Z direction. The counterpart case 500a has the oval insertion port 500c (an entrance to the counterpart fitting space 500b) as viewed from the Z direction. The fitting wall 21 has an oval outer peripheral surface 21a having a shape similar to that of the counterpart fitting space 500b.

The housing 20 includes the terminal housing portion 22 that houses the terminal fitting 10 inward. The terminal fitting 10 is inserted into a terminal housing chamber 20a along the +Z direction from an electric wire outlet 24a of the electric wire housing portion 24. The terminal housing portion 22 protrudes toward the +Z side with respect to the fitting wall 21. The terminal housing portion 22 is inserted into the counterpart fitting space 500b from the insertion port 500c together with the fitting wall 21.

The connector 1 is configured to generate a contact pressure between the contact and the counterpart terminal connection portion 511 due to elastic deformation of the elastic contact portion 13a without excess or deficiency. The terminal fitting 10 is housed in the terminal housing chamber 20a by moving relative to the counterpart terminal connection portion 511 in the acting direction of the contact pressure. The connector 1 has an aligning function of the terminal fitting 10 along the acting direction of the contact pressure. The terminal housing chamber 20a is formed in an indoor space in which the terminal fitting 10 can be relatively moved in the aligning direction (Y direction). The terminal housing chamber 20a is formed such that the terminal fitting 10 can be disposed with a gap from a first wall body 22a and a second wall body 22b of the terminal housing portion 22.

The first wall body 22a and the second wall body 22b are wall bodies forming the terminal housing chamber 20a in the terminal housing portion 22. The first wall body 22a and the second wall body 22b are arranged to face each other with a space therebetween in the aligning direction (Y direction). The size of the gap between each of the first wall body 22a and the second wall body 22b and the terminal fitting 10 is set such that a relative movement amount of the terminal fitting 10 with respect to the counterpart terminal connection portion 511 that can generate a contact pressure between the contact of the elastic contact portion 13a and the counterpart terminal connection portion 511 without excess or deficiency can be secured.

The terminal housing portion 22 is formed in an angular cylindrical shape. The angular cylindrical shaped terminal connection portion 11 is housed in the terminal housing chamber 20a inside the terminal housing portion 22. In the terminal housing portion 22, the counterpart terminal connection portion 511 is inserted into the terminal housing chamber 20a from one (+Z side) opening in the cylinder axial direction (Z direction). The counterpart terminal connection portion 511 is inserted into the terminal connection portion 11 in the terminal housing chamber 20a.

The housing 20 has the terminal housing portion 22 for each terminal fitting 10. In the housing 20, three terminal housing portions 22 are arranged at intervals in the X direction corresponding to the number of terminal fittings 10.

The housing 20 has a hood portion 23 disposed on the +Z side with respect to the fitting wall 21. The hood portion 23 is formed in a cylindrical shape that covers a protruding portion from the fitting wall 21 in each terminal housing portion 22 with a gap from the outside. The hood portion 23 is formed in an oval cylindrical shape having an oval outer peripheral surface having a shape similar to that of the counterpart fitting space 500b.

An oval-cylindrical-shaped counterpart terminal housing portion 521 of a counterpart housing 520 is fitted into an oval-annular-shaped gap between the hood portion 23 and each terminal housing portion 22. The counterpart housing 520 is fixed to the counterpart case 500a. The counterpart housing 520 is disposed in the counterpart fitting space 500b of the counterpart case 500a. Together with the counterpart terminal housing portion 521, each counterpart terminal connection portion 511 inside the counterpart terminal housing portion 521 is inserted into each terminal housing chamber 20a.

The hood portion 23 has an outer peripheral surface having a similar shape larger than the outer peripheral surface 21a of the fitting wall 21. The connector 1 includes an annular or cylindrical sealing member 51 (hereinafter, it is referred to as a "first sealing member 51".) that fills an annular or cylindrical gap between the outer peripheral surface 21a of the fitting wall 21 and the inner peripheral surface of the counterpart fitting space 500b in the circumferential direction. The first sealing member 51 is formed in an oval annular shape or an oval cylindrical shape of an oval shape similar to the shape of the counterpart fitting space 500b. The first sealing member 51 is assembled to the outer peripheral surface 21a of the fitting wall 21.

The housing 20 includes the electric wire housing portion 24 that houses the electric wire We inward and pulls out the electric wire We outward. The electric wire housing portion 24 is formed in a cylindrical shape. In the housing 20, the electric wire housing portion 24 is provided for each electric wire We. A cylindrical sealing member 52 (hereinafter, it is referred to as a "second sealing member 52".) that fills part of a cylindrical gap between the inner peripheral surface of the electric wire housing portion 24 and the outer peripheral surface 21a of the electric wire We is assembled inside the electric wire housing portion 24. The terminal fitting 10 attached to the terminal of the electric wire We is inserted from the electric wire outlet 24a of the electric wire housing portion 24 to the terminal housing chamber 20a. The connector 1 includes a rear holder 60 fitted into a gap between the electric wire outlet 24a of each electric wire housing portion 24 and the electric wire We.

### Shield Shell

The shield shell 30 is formed of a metal material (for example, aluminum or an aluminum alloy). The shield shell 30 has a function of suppressing intrusion of noise from the outside into the inner electric wire We by covering the electric wire housing portion 24 from the outside.

The shield shell 30 has the cylindrical-shaped cylindrical portion 31 that covers the electric wire housing portion 24 from the outside. The cylindrical portion 31 is formed in an oval cylindrical shape. In the housing 20, an oval-annular-shaped sealing member 53 (hereinafter, it is referred to as a "third sealing member 53".) is assembled to an oval outer peripheral surface on the electric wire housing portion 24 side with respect to the fitting wall 21. The third sealing member 53 functions as a waterproof member that fills a part of an oval- cylindrical-shaped gap between the oval outer peripheral surface of the housing 20 and the inner peripheral surface of the cylindrical portion 31 of the shield shell 30.

The shield shell 30 has the fixing portion 33 protruding to one side from the cylindrical portion 31 and fixed to the counterpart case 500a in a cantilevered manner. An oval-annular-shaped flange portion 32 is connected to the cylindrical portion 31. In the shield shell 30, the fixing portion 33 protruding from the flange portion 32 is screwed and fixed to a female screw portion N of the counterpart case 500a with a bolt B.

### Retaining Member

The connector 1 includes a retaining member 40 that holds the terminal fitting 10 in the terminal housing chamber 20a at the housing completion position. The retaining member 40 is formed of an insulating material such as synthetic resin. The retaining member 40 is assembled to the terminal housing portion 22. At the assembly completion position of the retaining member 40, the retaining member 40 has a function of preventing positional displacement of the terminal fitting 10 toward the electric wire outlet 24a and preventing the terminal fitting 10 from coming off from the electric wire outlet 24a. The retaining member 40 has a function of stopping movement of the terminal fitting 10 with respect to the terminal housing portion 22 in a terminal removal direction (-Z direction) opposite to the terminal insertion direction (+Z direction) at the assembly completion position. The retaining member 40 holds the terminal fitting 10 in the terminal housing chamber 20a at the housing completion position.

One retaining member 40 is provided for each terminal fitting 10. The retaining member 40 may be provided for each terminal fitting 10 or may be provided for each of the plurality of terminal fittings 10. The retaining member 40 may hold (retain) all the terminal fittings 10.

### Contact Portion

The fixing portion 33 of the shield shell 30 has a contact portion 34 that comes into contact with the counterpart case 500a in a cantilevered fixed state. The contact portion 34 includes a rib 35 provided at a protruding end of the fixing portion 33. The rib 35 protrudes to the +Z side from a surface (+Z side surface) facing the counterpart case 500a in the fixing portion 33. The rib 35 is integrally formed of the same member as the fixing portion 33. Note that the rib 35 may be formed of a member different from the member of the fixing portion 33.

The rib 35 has flexibility capable of bending at least in a direction in which it comes into contact with the counterpart case 500a. The rib 35 has flexibility capable of bending in the Z direction and in a direction intersecting the Z direction. The rib 35 is formed of, for example, a material softer than the counterpart case 500a (a portion of the counterpart case 500a with which the rib 35 contacts).

The rib 35 includes a first convex portion 35a provided at the protruding end of the fixing portion 33 and a second convex portion 35b extending from the first convex portion 35a along the outer edge of the fixing portion 33. The first convex portion 35a is formed in a rectangular shape as viewed from the Z direction. The second convex portion 35b extends from the +Y end of the first convex portion 35a to both sides in the X direction as viewed from the Z direction. The second convex portion 35b has a protrusion height lower than that of the first convex portion 35a in the Z direction. The protrusion height of the second convex portion 35b gradually decreases as it separates from the first convex portion 35a.

The fixing portion 33 is formed with a bolt hole 33h through which the bolt B for fixing to the counterpart case 500a in a cantilevered manner is inserted. The contact portion 34 is provided in the vicinity of the bolt hole 33h in the fixing portion 33. The bolt hole 33h is formed in a circular shape as viewed from the Z direction.

The contact portion 34 is provided at a distance equal to or less than several times the diameter of the bolt hole 33h from the center of the bolt hole 33h as viewed from the Z direction. For example, the contact portion 34 is preferably provided at a distance equal to or less than three times the diameter of the bolt hole 33h from the center of the bolt hole 33h as viewed from the Z direction, and more preferably provided at a distance equal to or less than two times the diameter of the bolt hole 33h.

### Holding Member

The connector 1 further includes a holding member 70 that causes the fixing portion 33 to hold the bolt B when the bolt B is detached from the counterpart case 500a. The holding member 70 is formed in an annular or arc shape along the outer periphery of the shaft portion of the bolt B. The holding member 70 is attached to the shaft portion of the bolt B. In the example of FIG. 6, the holding member 70 is formed in an arc shape along the outer periphery of the shaft portion of the bolt B and is fitted into a groove formed in the shaft portion of the bolt B. A space 33a for housing the holding member 70 is formed around the bolt hole 33h in the fixing portion 33 of the shield shell 30.

### Description When Fixing of Connector is Completed

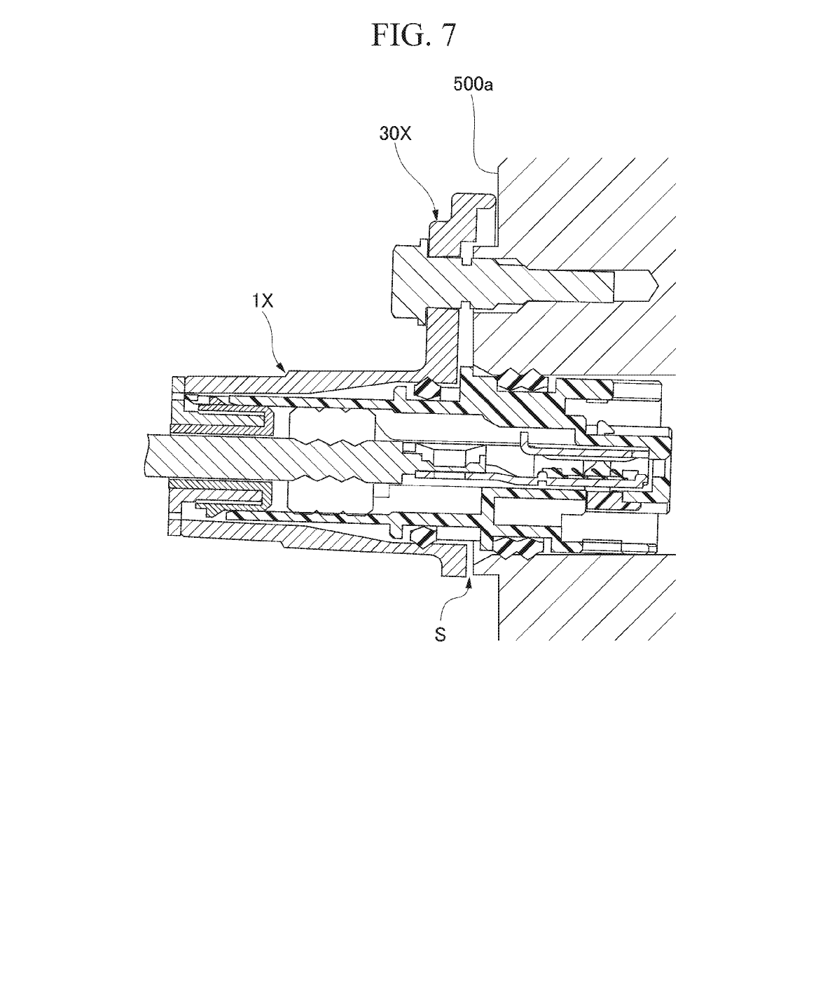

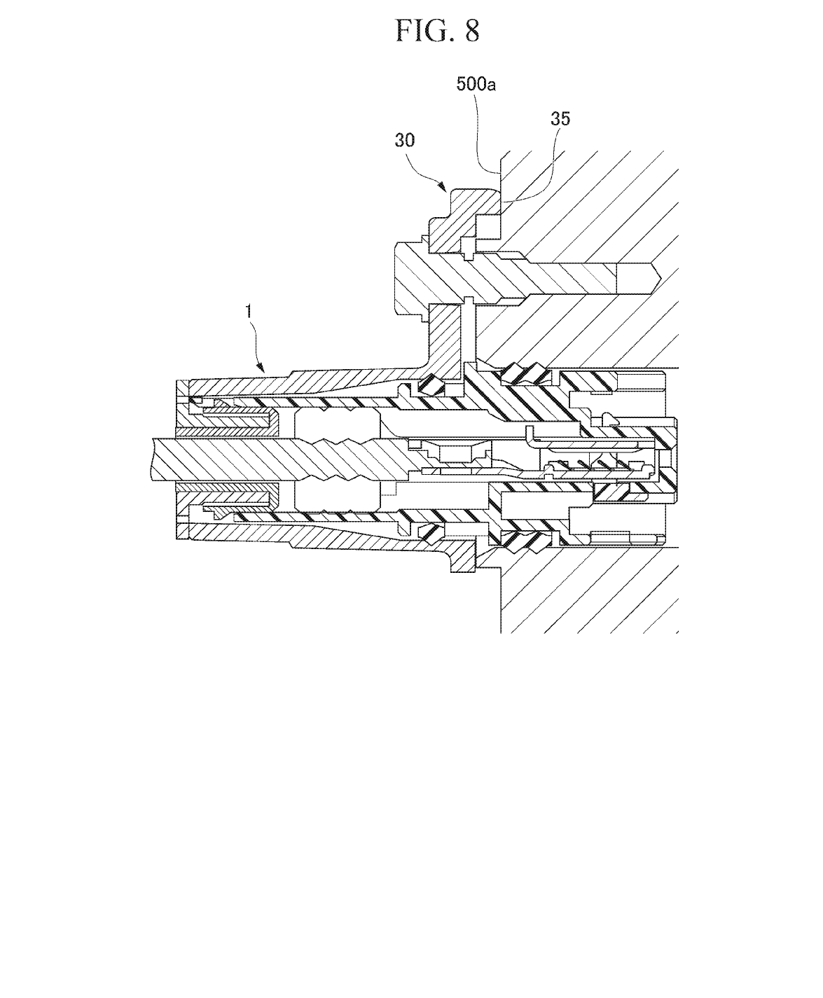

FIG. 7 is an explanatory view when fixing of the connector 1 of the comparative example is completed. FIG. 8 is an explanatory view when fixing of the connector 1 of the embodiment is completed.

As illustrated in FIG. 7, a connector 1X of the comparative example does not include a rib (contact portion) that comes into contact with the counterpart case 500a in a state where a shield shell 30X is fixed in a cantilevered manner. In the comparative example, the shield shell 30X is fixed to the counterpart case 500a in a cantilevered manner, and the shield shell 30X is inclined when the fixing is completed. When the shield shell 30X is inclined, a gap S is generated on the side opposite to the fixing side. In the comparative example, the gap S is generated between the connector 1X and the counterpart case 500a.

As illustrated in FIG. 8, the connector 1 of the embodiment includes the rib 35 that comes into contact with the counterpart case 500a in a state where the shield shell 30 is fixed in a cantilevered manner. In the embodiment, the shield shell 30 is fixed to the counterpart case 500a in a cantilevered manner, and the shield shell 30 is not inclined when the fixing is completed. In the embodiment, since the shield shell 30 is not inclined, it is possible to suppress generation of a gap between the connector 1 and the counterpart case 500a.

### Operation and Effects

As described above, the connector 1 of the present embodiment includes the terminal fitting 10 attached to the terminal of the electric wire We, the housing 20 having the terminal housing portion 22 that houses the terminal fitting 10 inward, and the electric wire housing portion 24 that houses the electric wire We inward and pulls out the electric wire We outward, and the shield shell 30 having the cylindrical-shaped cylindrical portion 31 that covers the electric wire housing portion 24 from the outside, and the fixing portion 33 that protrudes from the cylindrical portion 31 to one side and is fixed to the counterpart case 500a in a cantilevered manner. The fixing portion 33 includes the contact portion 34 that comes into contact with the counterpart case 500a in a cantilevered fixed state. According to this constitution, the shield shell 30 is less likely to incline when the fixing is completed, as compared with a case where the fixing portion 33 is not in contact with the counterpart case 500a in a cantilevered fixed state. Therefore, it is possible to suppress generation of a gap due to the inclination of the shield shell 30. By suppressing the generation of the gap, it is possible to avoid deterioration of the shield performance of the shield shell 30, damage due to external factors such as vibration, and the like. In addition, the waterproof property is improved. In addition, as compared with the case of adding the bolt fastening portion, the fastening work can be reduced and space can be saved.

In the present embodiment, the contact portion 34 includes the rib 35 provided at the protruding end of the fixing portion 33. According to this constitution, it is possible to suppress the generation of the gap due to the inclination of the shield shell 30 by the contact between the rib 35 and the counterpart case 500a. In addition, the waterproof property is improved as compared with a case where the rib 35 is provided inside the fixing portion 33 (close to the cylindrical portion 31).

In the present embodiment, the rib 35 has flexibility capable of bending at least in a direction in which it comes into contact with the counterpart case 500a. According to this constitution, it is possible to suppress the generation of the gap due to the inclination of the shield shell 30 by the bend of the rib 35. In addition, as compared with a case where the rib 35 is formed of a rigid body, it is possible to suppress damage or the like of the rib 35 due to an external factor such as vibration.

In the present embodiment, the rib 35 has the first convex portion 35a provided at the protruding end of the fixing portion 33, and the second convex portion 35b extending from the first convex portion 35a along the outer edge of the fixing portion 33. According to this constitution, as compared with a case where the rib 35 is provided only at the protruding end of the fixing portion 33 (the case where the second convex portion 35b is not provided), the contact surface between the rib 35 and the counterpart case 500a increases, so that it is possible to more effectively suppress the generation of the gap due to the inclination of the shield shell 30. In addition, the waterproof property is further improved.

In the present embodiment, the fixing portion 33 is formed with the bolt hole 33h through which the bolt B for fixing to the counterpart case 500a in a cantilevered manner is inserted. The contact portion 34 is provided in the vicinity of the bolt hole 33h in the fixing portion 33. According to this constitution, it is possible to suppress the generation of the gap due to the inclination of the shield shell 30 by the contact portion 34 in the vicinity of the bolt hole 33h. In addition, as compared with a case where the contact portion 34 is provided at a predetermined distance or more from the bolt hole 33h in the fixing portion 33, generation of backlash can be suppressed and space can be saved.

In the present embodiment, the connector 1 further includes the holding member 70 that causes the fixing portion 33 to hold the bolt B when the bolt B is detached from the counterpart case 500a. According to this constitution, when the bolt B is detached from the counterpart case 500a, the holding member 70 prevents the bolt B from being detached from the fixing portion 33.

### Second Embodiment

Hereinafter, a connector according to a second embodiment will be described. In the following description, portions having the similar functions to those described in the first embodiment are denoted by the similar names and reference numbers, and a specific description thereof will be omitted.

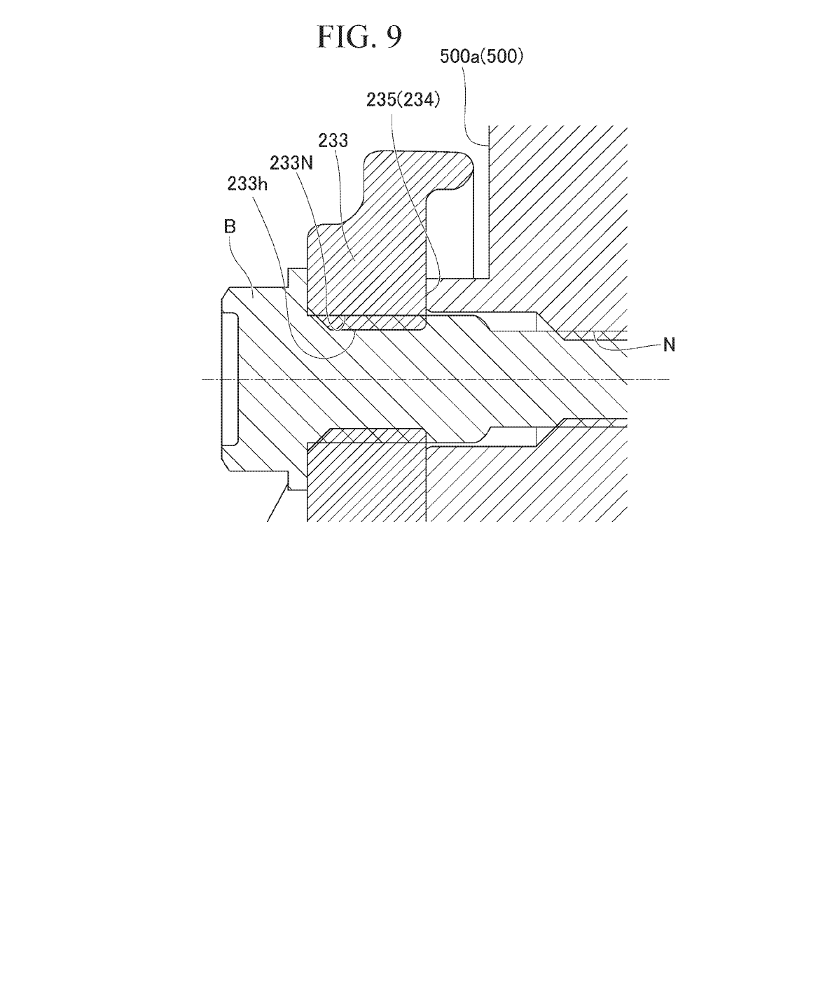

FIG. 9 is a cross-sectional view corresponding to FIG. 6, illustrating the connector of the second embodiment together with the counterpart case 500a.

As illustrated in FIG. 9, the contact portion 234 includes a surface 235 provided around the bolt hole 233h in the fixing portion 233. The surface 235 provided around the bolt hole 233h is formed in a planar shape parallel to the XY plane.

The fixing portion 233 has a female screw 233N with which the bolt B is screwed into the inner periphery of the bolt hole 233h. The female screw 233N is provided over the opening direction (Z direction) of the bolt hole 233h on the inner periphery of the bolt hole 233h. The bolt B has a male screw portion screwed into the female screw 233N. The male screw portion of the bolt B is longer than the bolt hole 233h in the Z direction.

The female screw 233N is threaded in a direction opposite to the direction in which the bolt B is detached from the counterpart case 500a. In other words, the female screw 233N is threaded in the same direction as the female screw portion N provided in the counterpart case 500a.

As described above, in the present embodiment, the contact portion 234 includes the surface 235 provided around the bolt hole 233h in the fixing portion 233. According to this constitution, it is possible to suppress the generation of the gap due to the inclination of the shield shell by the contact between the surface 235 around the bolt hole 233h and the counterpart case 500a. In addition, generation of backlash due to clearance around the bolt hole 233h can be suppressed and space can be saved.

In the present embodiment, the fixing portion 233 has the female screw 233N with which the bolt B is screwed on the inner periphery of the bolt hole 233h. According to this constitution, the holding member 70 that causes the fixing portion 233 to hold the bolt B when the bolt B is detached from the counterpart case 500a becomes unnecessary.

By eliminating the holding member 70, it is possible to suppress generation of backlash due to the clearance around the bolt hole 233h and it is possible to more effectively suppress the generation of the gap due to the inclination of the shield shell. In addition, this contributes to reduction in the number of components and work processes.

In the present embodiment, the female screw 233N is threaded in a direction opposite to the direction in which the bolt B is detached from the counterpart case 500a. According to this constitution, as compared with a case where the female screw 233N is threaded in the same direction as the direction in which the bolt B is detached from the counterpart case 500a, it is possible to suppress detachment of only the bolt B when the bolt B is detached from the counterpart case 500a and the fixing of the shield shell is released. That is, it is easy to detach the bolt B together with the shield shell.

### Third Embodiment

Hereinafter, a connector according to a third embodiment will be described. In the following description, portions having the similar functions to those described in the first embodiment are denoted by the similar names and reference numbers, and a specific description thereof will be omitted.

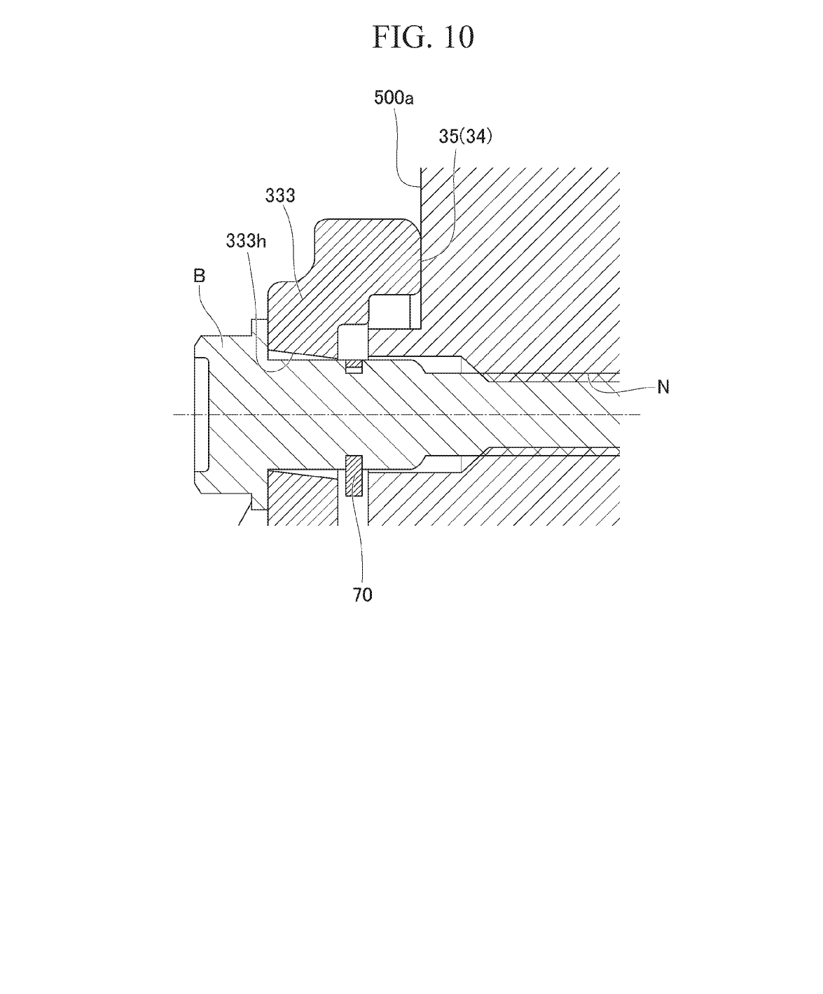

FIG. 10 is a cross-sectional view corresponding to FIG. 6, illustrating the connector of the third embodiment together with the counterpart case 500a.

As illustrated in FIG. 10, a bolt hole 333h through which the bolt B for fixing to the counterpart case 500a in a cantilevered manner is inserted is formed in a fixing portion 333. The bolt hole 333h is formed so as to open obliquely with respect to the axial direction of the bolt B in a state where the fixing portion 333 is fixed in a cantilevered manner. In the example of FIG. 10, the bolt hole 333h is inclined with respect to the axial direction of the bolt B so as to be positioned on the -Y side as it goes toward the +Z side. A portion of the shaft portion of the bolt B on the -Y side and the -Z side is in contact with a portion of the inner peripheral surface of the bolt hole 333h on the -Y side and the -Z side ends.

As described above, in the present embodiment, the bolt hole 333h is formed so as to open obliquely with respect to the axial direction of the bolt B in a state where the fixing portion 333 is fixed in a cantilevered manner. According to this constitution, it is possible to suppress the generation of the gap due to the inclination of the shield shell by the contact between the inner peripheral surface of the bolt hole 333h that opens obliquely and the shaft portion of the bolt B.

### Modification Example

In the above-described embodiment, an example has been described in which the contact portion includes the rib provided at the protruding end of the fixing portion, but the present invention is not limited to this example. For example, the contact portion may include the rib provided inside the fixing portion (close to the cylindrical portion). For example, the contact portion may include a convex portion protruding from a part of the fixing portion toward the counterpart case. The constitution aspect of the contact portion can be changed according to the design specifications.

In the above-described embodiment, an example has been described in which the rib includes the first convex portion provided at the protruding end of the fixing portion and the second convex portion extending from the first convex portion along the outer edge of the fixing portion, but the present invention is not limited to this example. For example, the rib may be provided only at the protruding end of the fixing portion. For example, the rib does not need to have the second convex portion. The constitution aspect of the rib can be changed according to the design specifications.

In the above-described embodiment, an example has been described in which the rib has flexibility capable of bending at least in a direction in which the rib comes into contact with the counterpart case, but the present invention is not limited to this example. For example, the rib may be formed of a rigid body. For example, the rib may be made of a material (metal) having higher rigidity than the counterpart case. The constitution aspect of the rib can be changed according to the design specifications.

In the above-described embodiment, an example has been described in which a bolt hole through which a bolt for fixing to the counterpart case in a cantilevered manner is inserted is formed in the fixing portion, and the contact portion is provided in the vicinity of the bolt hole in the fixing portion, but the present invention is not limited to this example. For example, the contact portion may be provided at a predetermined distance or more from the bolt hole in the fixing portion. An installation aspect of the contact portion in the fixing portion can be changed according to design specifications.

In the above-described embodiment, an example has been described in which the contact portion is a surface provided around the bolt hole in the fixing portion, but the present invention is not limited to this example. For example, the contact portion may be a convex portion provided around the bolt hole in the fixing portion. The aspect of the contact portion can be changed according to the design specifications.

In the above-described embodiment, an example has been described in which the female screw is threaded in the direction opposite to the direction in which the bolt is detached from the counterpart case, but the present invention is not limited to this example. For example, the female screw may be threaded in the same direction as the direction in which the bolt is detached from the counterpart case. The direction in which the female screw is threaded can be changed according to the design specifications.

In the above-described embodiment, an example has been described in which the connector further includes the holding member that causes the fixing portion to hold the bolt when the bolt is detached from the counterpart case, but the present invention is not limited to this example. For example, the connector does not need to include the holding member. An installation aspect of the holding member can be changed according to design specifications.

Although the embodiments and modification examples have been described above, the embodiments and modification examples are not limited to these examples. The embodiments and modification examples can be modified by addition, omission, substitution, or other changes to the constitution, and can be combined with each other, without departing from the spirit of the present disclosure. Accordingly, the invention is not to be considered as being limited by the foregoing description, and is only limited by the scope of the appended claims.

### Reference Signs List

1 Connector

10 Terminal fitting

20 Housing

22 Terminal housing portion

24 Electric wire housing portion

30 Shield shell

31 Cylindrical portion

33, 233, 333 Fixing portion

33h, 233h, 333h Bolt hole

34, 234 Contact portion

35 Rib

35a First convex portion

35b Second convex portion

70 Holding member

233N Female screw

235 Surface

500a Counterpart case

B Bolt

We Electric wire

What is claimed is:

1. A connector comprising:
a terminal fitting attached to an terminal of an electric wire;
a housing including a terminal housing portion that houses the terminal fitting inward and an electric wire housing portion that houses the electric wire inward and pulls out the electric wire outward; and
a shield shell including a cylindrical-shaped cylindrical portion that covers the electric wire housing portion from the outside and a fixing portion that protrudes to one side from the cylindrical portion and is fixed to a counterpart case in a cantilevered manner,
wherein the fixing portion includes a contact portion that comes into contact with the counterpart case in the cantilevered fixed state.

2. The connector according to claim 1,
wherein the contact portion includes a rib provided at a protruding end of the fixing portion.

3. The connector according to claim 2,
wherein the rib has flexibility capable of bending at least in a direction in which the rib comes into contact with the counterpart case.

4. The connector according to claim 2, wherein the rib includes:
a first convex portion provided at a protruding end of the fixing portion; and
a second convex portion extending from the first convex portion along an outer edge of the fixing portion.

5. The connector according to claim 1,
wherein a bolt hole through which a bolt for fixing in the cantilevered manner with respect to the counterpart case is inserted is formed in the fixing portion, and
the contact portion is provided in the vicinity of the bolt hole in the fixing portion.

6. The connector according to claim 5,
wherein the contact portion includes a surface provided around the bolt hole in the fixing portion.

7. The connector according to claim 5,
wherein the bolt hole is formed to open obliquely with respect to an axial direction of the bolt in a state where the fixing portion is fixed in the cantilevered manner.

8. The connector according to claim 5,
wherein the fixing portion has a female screw into which the bolt is screwed, on an inner periphery of the bolt hole.

9. The connector according to claim 8,
wherein the female screw is threaded in a direction opposite to a direction in which the bolt is detached from the counterpart case.

10. The connector according to claim 5,
further comprising a holding member that causes the fixing portion to hold the bolt when the bolt is detached from the counterpart case.
